(19) United States
(12) Patent Application Publication
(10) Pub. No.: US 2002/0180806 A1
(43) Pub. Date: Dec. 5, 2002

(54) System and method for upgrading input and inquiry efficiency

(75) Inventors: HaiMing Zhang, Shanghai (CN); David Ho, Sanchung City (TW); Tony Tsai, Hsinchu (TW)

Correspondence Address: DOUGHERTY & TROXELL, SUITE 1404, 5205 LEESBURG PIKE, FALLS CHURCH, VA, 22041, US

(73) Assignee: Inventec Appliances Corp.

(21) Appl. No.: 09/871,819

(22) Filed: Jun. 4, 2001

(51) Int. Cl. G06F 3/00

(52) U.S. Cl. 345/816; 345/864

(57) ABSTRACT

A system and method for upgrading inquiry efficiency of mobile phones, PDAs, or handheld devices having CCITT standard keypads is disclosed. In one embodiment, an individual may press keys to give at least one key values, whereas conversions to key values are activated to obtain mandarin pinyin syllables or phonetic notations associated with all input modes. Combinations of all pinyin syllables or phonetic notations are then derived to establish all word lists based on all input modes. Non-idiomatic character combinations are then eliminated before showing one of the word lists according to the currently employed input mode. An individual may select one from the shown word list to access detailed information contained in the selected one for further selections.

### BACKGROUND OF THE INVENTION

1. Field of the Invention

The present invention relates to a system and method for upgrading input and inquiry efficiency. More specifically, the present invention relates to a system and method for a device or system, such as a mobile phone, a PDA, or even a handheld device, which possesses a CCITT standard keypad and accompanied with friendly interfaces to upgrade input and inquiry efficiency via mandarin or Chinese characters.

In a specific application, the present invention relates to a system and method for inquiring information according to keywords given by individuals from CCITT standard keypads based on input modes currently employed.

In another specific application, the present invention relates to a system and method for real-time displaying inquiry information according to the currently employed or switched input mode.

2. Description of the Prior Art

Advancements in electrical engineering and communication networks allow the modem world to exhibit various appearances everyday. A manifest fact is that information in different formats or characteristics is derived and delivered more frequently than before. Also due to the prosperous developments of the modem technologies, the ways of telephony communications have made progress from delivering data by means of various fixed transference lines to wireless communications. Mobile phones or cellular phones are therefore become essentially portable devices for modem persons nowadays.

Because of portable requirements, conventional mobile phones usually possess user interfaces such as keypads or displays having small sizes than common computers. For example, a mobile phone in FIG. 1 encompasses user interfaces including LCD 110 and a keypad 102 fitting in with the CCITT (Consultative Committee in International Telegraphy and Telephony) standard, control buttons 104A and 104B, direction buttons 106, left button 108A, right button 108B, and menu button 112. The CCITT standard keypad 102 contains 12 keys “1”, “2ABC”, “3DEF”, “4GHI”, “5”JKL, “6MNO”, “7PQRS”, “8TUV”, “9WXY Z”, “*”, “0”, and “#” in the embodiment. When an individual wishes to input a specific number or character, he or she can press associated keys accompanied with continuous key-pressings under associated pressing times. For example, an individual can press key “9WXYZ” three times to input English character “X”. Therefore an individual may inquire required information from a conventional mobile phone based on the aforementioned input mechanism.

However, it is quite a difficult job for an individual to request information by means of mandarin or Chinese characters from a conventional mobile phone only by employing such few keys. An individual should give so many key-pressing operations to complete only one Chinese character under information inquiry. For example, if an individual wishes to input a Chinese character “ [symbol] ” having pinyin Romanization syllables “SHANG”, he or she should firstly press key “7PQRS”four times for “S” (the numeral “7” will not be shown in pinyin mode). Subsequently, he or she should respectively press key “4GHI” three times for “H”, key “2ABC” once for “A”, key “6MNO” twice for “N”, and finally key “4GHI” once for G. Ten key-pressings are obviously needed to finish input sequences for Chinese character “ [symbol] ”, which significantly indicates that conventional input approach is obviously inconvenient for an individual from usage. Another disadvantage is that an individual should give complete Chinese or English characters (or even words) for information inquiry. That complicated input sequences are required for inputting such words should significantly confuses an individual when inquiry.

On the other hand, conventional mobile phones are ordinarily sorted by character coding (e.g., Big 5 coding), therefore any person who is unfamiliar with foreign languages can not inquire desire information based on his or her practices. For an individual who is accustomed to Chinese or mandarin pinyin syllables, the different sorting schemes under Big 5 coding in mobile phones may confuse the individual when inquiring information. No correct information may be obtained under the above inquiry situations. There is a need to disclose a novel system and method for overcoming the aforementioned disadvantages and satisfy requirements of modern mobile phones.

### SUMMARY OF THE INVENTION

The principal object of the invention is the provision of a system and method for upgrading inquiry efficiency by decreasing input sequences.

The other object of the invention is the provision of a system and method for upgrading inquiry efficiency of devices having keyboards fitting in with CCITT standard.

Another object of the invention is the provision of a system and method for inquiring information from mobile phones based on input modes familiar by individuals.

A further object of the invention is the provision of a system and method for real-time displaying inquired information according to input mode currently employed.

A still further object of the invention is the provision of a system and method for real-time displaying inquired information based on current input characters from an individual.

In one embodiment, an individual may press keys of mobile phones to give at least one Chinese or mandarin phonetic notation or pinyin syllable. Key values associated with the pressed keys are then converted to obtain notations or pinyin syllables associated with all input modes. All notations or pinyin syllables are then integrated into character combinations (or, strings), which are treated as keywords to activate comparison and inquiry operations to the mobile phone respectively to input modes. Word lists based on different input modes are then derived. One of the word lists related to the currently employed input mode is then shown to individual, he or she may select a word from the shown word list, whereas the contents associated with the selected word are accessed and shown to individual for further selections. Additionally, when an individual switches input mode currently employed to another, the embodiment real-time shows the word list according to the currently employed one after switching by individual.

In the embodiment, the disclosed system basically encompasses an input device, a display device, a processing device, a memory device, a recognition module, and a character database module. Input device is used to receive commands or keywords from individuals, whereas the display device shows messages to individuals via optical signals. Processing device performs all operations of the disclosed system, e.g., interpreting commands or keywords from individuals, displaying information in the display device via optical signals, accessing or storing data from the memory device, executing programs of the recognition module to perform character or word comparison and information inquiry based on keywords input by individuals, and accessing associated word information from character and word module to individuals according to inquired information. Memory device stores programs and temporary data executed and derived by processing device. Recognition module stores programs executed by the processing device for receiving key values from keypads, converting received key values to obtain notations or syllables indicated by individuals, comparing and inquiring information by employing keywords that are integrated from all obtained notations or syllables, and accessing words accompanied with associated information from the character and word module based on the inquired information. Character and word module possesses databases including Chinese characters sorted by mandarin phonetic notations and pinyin syllables.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts an exemplary diagram illustrative of an input interface of a mobile phone according to the embodiment;

FIG. 2 depicts a schematic diagram of the disclosed system according to the embodiment;

FIG. 3 depicts a flowchart illustrative of the operating sequences according to the embodiment;

FIG. 4A depicts an exemplary diagram for showing a word list in LCD of a mobile phone when an individual gives a keyword by means of Chinese pinyin syllables;

FIG. 4B depicts an exemplary diagram illustrative of when an individual selects one from the shown word list in FIG. 4A;

FIG. 4C depicts an exemplary diagram illustrative of when an individual selects one from the shown word list in FIG. 4B;

FIG. 5A depicts an exemplary diagram for showing a word list in LCD of a mobile phone when an individual only gives portions of a keyword by means of Chinese pinyin syllables;

FIG. 5B depicts an exemplary diagram when an individual selects a word from the shown word list in LCD of the mobile phone in FIG. 5A;

FIG. 5C depicts an exemplary diagram when an individual selects a word from the shown word list in LCD of the mobile phone in FIG. 5B; and

FIG. 6 depicts a mapping list employed by a keypad according to embodiment.

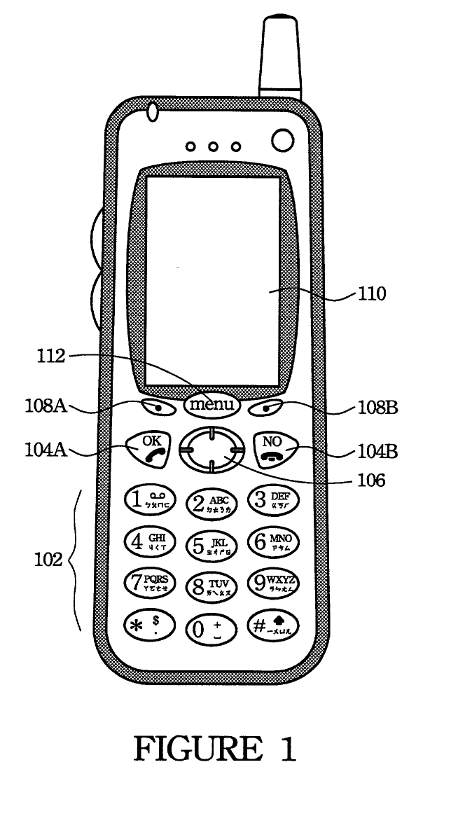

### DESCRIPTION OF THE PREFERRED EMBODIMENT

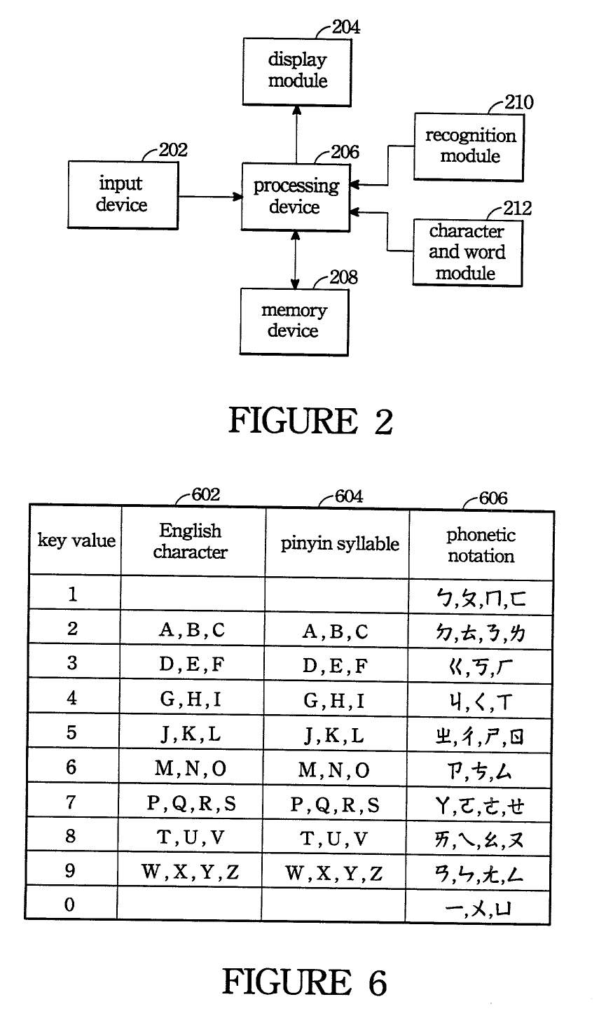

Please firstly refer to FIG. 2, a schematic diagram for demonstrating the system according to the embodiment is shown therein, wherein the disclosed system basically encompasses input device 202, display device 204, processing device 206, memory device 208, recognition module 210, and word and phrase module 212. Input device 202 receives commands or keywords from individuals, whereas display device 204 shows messages or information to individuals via optical signals. Processing device 206 performs all operations of the disclosed system. For example, those operations of interpreting commands or keywords input from individuals, displaying associated messages in display device 204 to individuals via optical signals, accessing or storing data from/in memory device 208, executing programs of recognition module 210 to perform comparisons to character combination and information inquiry based on input keywords from individuals (detailed descriptions are given later), and accessing relative characters or words from the character and word module 212 to show to individuals according to inquired information performed in processing device 206. Memory device 208 stores temporary data derived by processing device 206, e.g., optical signals for showing characters or words to individuals. Recognition module 210 stores programs executed by the processing device 206 for receiving key values from keypad 102 (also including key-pressing times), converting received key values to obtain characters indicated by individuals, comparing and inquiring information by employing keywords integrated by mandarin phonetic notations or pinyin syllables, and accessing word accompanied with associated information from character and word module 212 based on the inquired information. Character and word module 212 possesses databases including Chinese characters sorted by Chinese phonetic notations and pinyin syllables.

FIG. 6 depicts a list for showing key values input from keypad 102 associated with each input mode, wherein each column 602, 604, 606 in FIG. 6 respectively indicate key values relative to input modes by means of English characters, mandarin pinyin syllables, and phonetic notations. Notably, FIG. 6 only shows exemplary key values used in the embodiment, a skilled person can modify the embodiment as specifications and requirements but all similar arrangements within the spirit of the embodiment should be included in the appended claims.

As noted, all components shown in FIG. 2 may be established or mounted by conventional devices. For example, input device 202 can be any conventional CCITT standard keypad, display device 204 can be a LCD, and processing device 206 can be a microprocessor, whereas memory device 208 can be any kind of memory for storing temporary data of the mobile phone. Furthermore, recognition module 210 and character and word module 212 may be mounted in flash memory of the mobile phone. A skilled person can modify the embodiment as specifications and requirements but all similar arrangements within the spirit of the embodiment should be included in the appended claims.

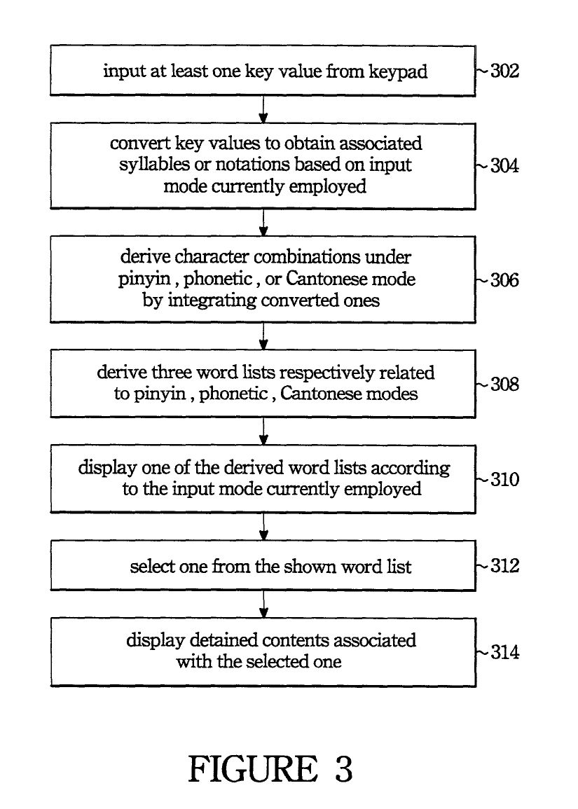

Please next refer to FIG. 3, a flowchart illustrative of operating sequences of the embodiment is shown therein. Firstly, if an individual presses keys to input a mandarin phonetic notations or pinyin syllables (step 302), notations or pinyin syllables relative to the pressed keys will be obtained by means of key value conversions based on the list of FIG. 6 (step 304). Combinations of all notations or pinyin syllables (or, strings) respectively relative to input modes including pinyin, phonetic, and Cantonese modes are then derived (step 306). Next, the disclosed system activates comparison and inquiry operations to phone book of the mobile phone by employing all the character combinations (or strings) and derives word lists relative to above input modes, respectively (step 308). One of the derived lists is shown to individual based on the currently employed input mode (step 310). An individual may select one from the shown list (step 312), whereas the detailed contents of the selected one are accessed and shown to individual via display device 104 (step 314).

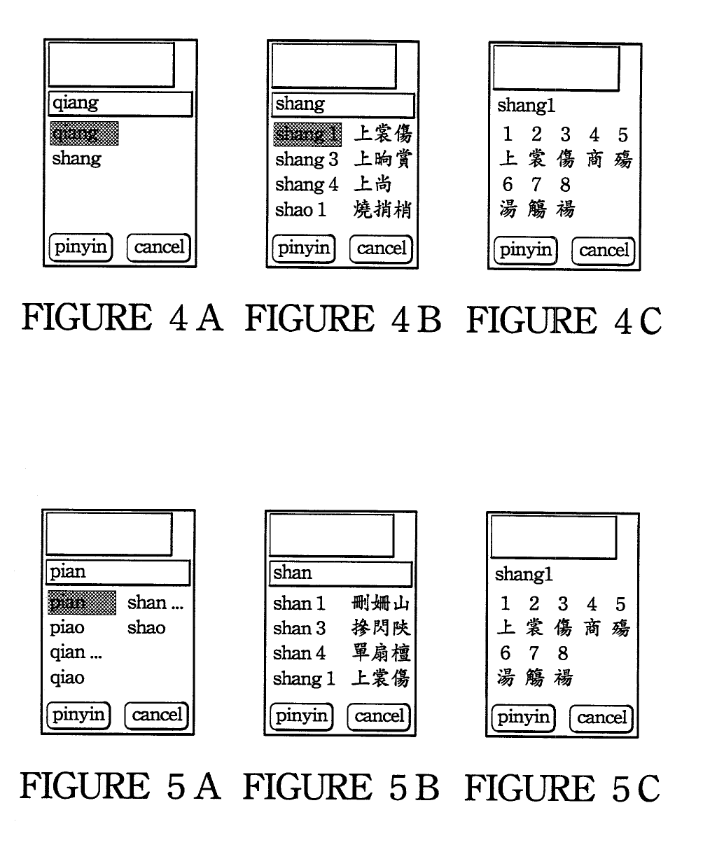

Notably, sequential key values may be input in step 302, whereas all non-idiomatic combinations will be eliminated. For example, when an individual sequentially presses keys “7PQRS”, “4GHI”, “2ABC”, “6MNO”, “4GHI”, several pinyin combinations, e.g., “PIANG”, “QIANG” . . . “SHANG” can be derived by means of the above key values. However, only “QIANG” and “SHANG” are idiomatic combinations after eliminating non-idiomatic ones. Practically, if an individual sequentially presses the above keys to give keywords under pinyin mode, the disclosed system will show FIG. 4A in step 310. However, when an individual selects “SHANG” by means of direction button 106 in step 312, the disclosed system then shows FIG. 4B in step 314, which encompasses mandarin pinyin syllables “SHANG” accompanied with mandarin tones indicated by “1”, “2”, “3”, “4” shown at the right-most side. For example, “SHANG1” is used to indicate mandarin characters having pinyin “SHANG” with first tone in mandarin, which contains “ [symbol] ”, “ [symbol] ”, “ [symbol] ”, “ [symbol] ” . . . , etc. Actually, due to many homophony characters in Chinese, each combination of the word list (whether pinyin, Cantonese, or phonetic mode) may possess all homophony characters. An individual may therefore select one from the shown word list to activate further lists containing detailed character combinations for selections. Steps 312 and 314 may continuously perform until an individual determines a word from the list or cancels currently input action. For example, an individual may select “SHANG1” in FIG. 4B by means of direction button 106, whereas the disclosed system successively shows figure of FIG. 4C.

Obviously, an individual can sequentially press keys for giving pinyin syllables or phonetic notations instead of selecting required ones by successively key-pressings in every associated key (e.g., selection “ [symbol] ” described in prior art). A convenient, friendly and efficient interface is provided for information inquiry in the embodiment because less input sequences than conventional approaches are needed. Additionally, comparison and inquiry operations are performed to all input modes in step 310, therefore the disclosed system can real-time display a word list based on the switched input mode. An individual may give keywords according to his or her custom and select words in mobile phones, which indicates that the disadvantage of conventional approaches that an individual can not switch input mode when inputting is overcome.

It is only an exemplar that an individual gives complete mandarin pinyin syllables or phonetic notations in the embodiment, e.g., a mandarin character “ [symbol] ” is given under pinyin mode as mentioned above. However, practically, the disclosed system may display the word list associated with each additional given syllable or notation from an individual. For example, the disclosed system may display FIG. 5A when an individual has input “SHAN” for mandarin character “ [symbol] ”, wherein an appended symbol “. . . ” indicates further “meaningful” character combinations included under the displayed one, e.g., “SHAN” may append syllable “G” to be “SHANG”. When an individual selects “SHAN . . . ” in FIG. 5A (via direction buttons 106), the disclosed system can demonstrates FIG. 5B to individual. Therefore if an individual presses “SHANG1” in FIG. 5B, FIG. 5C will be displayed later. Obviously, a convenient way that requires less input sequences than before when giving mandarin characters in mobile phone is provided by the present invention.

On the other hand, except mobile phones, PDA (Personal digital assistants), any handheld device, or a system or device by using CCITT standard keypad for receiving keywords may employ the embodiment to upgrade inquiry efficiency by means of Chinese characters. Additionally, although Chinese characters are used for explanations in the embodiment, however, any language that may employ pinyin syllables, for example, Korean or Japanese characters, may apply the invention to receive keywords for information inquiry. Notably, all similar arranges or modifications within the spirit of the embodiment should be included in the appended claims.

In conclusion, the invention discloses a system and method for upgrading information inquiry efficiency by means of a friendly input approach that decreases input sequences for giving keywords by using mandarin pinyin syllables or phonetic notations when CCITT standard keypads are employed. Any portable device, such as mobile phone, PDA, or any mechanism that mounts the CCITT standard keypad may employ the invention to offer individuals an easy way for information inquiry. One of those word lists associated with currently employed input mode may be real-time shown to individual even after switching. The disadvantage of conventional approaches that an individual can not switch input mode when inputting and give keywords via successively key-pressings in every associated key is overcome in the invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for upgrading inquiry efficiency of an apparatus mounting a CCITT (Consultative Committee in International Telegraphy and Telephony) standard keypad, said method comprising the steps of:
inputting a keyword having at least one character;
inquiring information from a database of said apparatus by means of comparisons to said keyword; and
displaying inquired information according to an input mode currently employed by said apparatus.

2. The method according to claim 1, said inquired information comprising a plurality of word lists, wherein each one of said word lists is derived according to one of said input modes provided by said apparatus.

3. The method according to claim 2, further comprising:
selecting a character combination included in said inquired information, wherein said inquired information includes one of said word lists based on said input mode currently employed by said apparatus; and
displaying a further word list according to said selected character combination.

4. The method according to claim 1, said input mode being activated to receive an English character, a mandarin phonetic notation, or a mandarin pinyin syllable.

5. The method according to claim 1, further comprising:
switching said input mode currently employed by said apparatus to another input mode; and
displaying one of said word lists according to said input mode after switching.

6. The method according to claim 1, further comprising:
inputting a character;
combining said input character to said keyword to derive a new keyword;
inquiring information from a database of said apparatus to obtain new inquired information by means of comparisons to said new keyword; and
displaying said new inquired information according to an input mode currently employed by said apparatus.

7. The method according to claim 6, said new inquired information comprising a plurality of new word lists, wherein each one of said new word lists is derived according to one of said input modes provided by said apparatus.

8. A system for upgrading inquiry efficiency of an apparatus mounting a CCITT (Consultative Committee in International Telegraphy and Telephony) standard keypad, said system comprising:
a database;
a storage device for storing computer executable instructions; and
a processing device coupled with said storage device for operating said computer executable instructions to
inquire information from said database by using a keyword based on all input mode provided by said apparatus; and
display said inquired information according to one of said input mode currently employed by said apparatus.

9. The system according to claim 8, said inquired information comprising a plurality of word lists, wherein each one of said word lists is derived according to one of said input modes.

10. The system according to claim 9, said processing device operating said computer executable instructions to
select a character combination included in said inquired information, wherein said inquired information includes one of said word lists based on said input mode currently employed by said apparatus; and
display a new word list according to said selected character combination.

11. The system according to claim 8, said input mode being activating to receive an English character, a mandarin phonetic notation, or a mandarin pinyin syllable.

12. The system according to claim 8, said processing device operating said computer executable instructions to
switch said input mode currently employed by said apparatus to another input mode; and
display one of said word lists according to said input mode after switching.

13. The system according to claim 8, said processing device operating said computer executable instructions to
input a character;
combine said input character to said keyword to derive a new keyword;
inquire information from a database of said apparatus to obtain new inquired information by means of comparisons to said new keyword; and
display said new inquired information according to an input mode currently employed by said apparatus.

14. The system according to claim 13, said new inquired information comprising a plurality of new word lists, wherein each one of said new word lists is derived according to one of said input modes provided by said apparatus.

15. A storage medium for storing programs for upgrading inquiry efficiency of an apparatus mounting a CCITT (Consultative Committee in International Telegraphy and Telephony) standard keypad, said storage medium having said programs for performing steps comprising:
inputting a keyword having at least one character;
inquiring information from a database of said apparatus by means of comparisons to said keyword; and
displaying inquired information according to an input mode currently employed by said apparatus.

16. The storage medium according to claim 15, said inquired information comprising a plurality of word lists, wherein each one of said word lists is derived according to one of said input modes provided by said apparatus.

17. The storage medium according to claim 16, said storage medium having said programs for performing steps comprising:
selecting a character combination from said shown word list; and
displaying a further word list including in said selected word list.

18. The storage medium according to claim 15, said input mode being activated to receive an English character, a mandarin phonetic notation, or a mandarin pinyin syllable.

19. The storage medium according to claim 15, said storage medium having said programs for performing steps comprising:
switching said input mode currently employed by said apparatus to another input mode; and
displaying one of said word lists according to said input mode after switching.

20. The storage medium according to claim 15, said storage medium having said programs for performing steps comprising:
inputting a character;
combining said input character to said keyword to derive a new keyword;
inquiring information from a database of said apparatus to obtain new inquired information by means of comparisons to said new keyword; and
displaying said new inquired information according to an input mode currently employed by said apparatus.
